(19) United States
(12) Patent Application Publication
(10) Pub. No.: US 2021/0070916 A1
(43) Pub. Date: Mar. 11, 2021

(54) POLYURETHANE FOAMS BASED ON POLYETHER CARBONATE POLYOLS

(71) Applicant: Covestro Intellectual Property GmbH & Co. KG, Leverkusen (DE)

(72) Inventors: Persefoni Hilken, Leverkusen (DE); Stefan Lindner, Remscheid (DE); Joerg Hofmann, Krefeld (DE); Klaus Lorenz, Dormagen (DE)

(21) Appl. No.: 17/040,586

(22) PCT Filed: Apr. 4, 2019
(86) PCT No.: PCT/EP2019/058522

§ 371 Date: Sep. 23, 2020

(30) Foreign Application Priority Data
Apr. 6, 2018 (EP) 18166042.4

(51) Int. Cl. C08G 18/12; C08G 18/08; C08G 18/16; C08G 18/18; C08G 18/24; C08G 18/44; C08G 18/48; C08G 18/76; C08G 18/38; C08J 9/12

(52) U.S. Cl. CPC C08G 18/12; C08G 18/14; C08G 18/165; C08G 18/1833; C08G 18/244; C08G 2101/0008; C08G 18/48; C08G 18/7621; C08G 18/3885; C08J 9/125; C08J 2375/08; C08G 18/44

(57) ABSTRACT

A process for producing polyurethane foams by reaction of the components: A, B, C, and D. Component A comprises a polyol component, comprising A1 which is 40 to 100 parts by weight of polyether carbonate polyol and A2 which is 0 to 60 parts by weight of polyether polyol. Component B can comprise B1 a catalyst, and B2 optionally auxiliary and additive substances. Component C can comprise water and/or physical blowing agents. Component D can comprise di- and/or polyisocyanates. Production is carried out at an index of 90 to 120 and in the presence of a component K, wherein the component K comprises a reaction product of alkoxylated phosphoric acid with 1,3-dicarbonyl compound or carboxylic anhydride. A polyurethane foam and a method for producing articles are also disclosed.

### CROSS REFERENCE TO RELATED APPLICATIONS

This application is a U.S. national stage application, filed under 35 U.S.C. § 371, of International Application No. PCT/EP2019/058522, which was filed on Apr. 4, 2019, and which claims priority to European Patent Application No. 18166042.4, which was filed on Apr. 6, 2018. The contents of each are incorporated by reference into this specification.

### FIELD

The present invention relates to a process for producing polyurethane foams, preferably flexible polyurethane foams, by reaction of an isocyanate component with a component which is reactive toward isocyanates and comprises at least one polyether carbonate polyol, with the reaction taking place in the presence of a component K which will be described in more detail below. The invention further relates to polyurethane foams produced by the process of the invention and the use thereof.

### BACKGROUND

In the context of an environmentally friendly configuration of production processes, it is generally desirable to use CO₂-based starting materials, for example in the form of polyether carbonate polyols, in relatively large amounts. The preparation of polyether carbonate polyols by catalytic reaction of alkylene oxides (epoxides) and carbon dioxide in the presence of H-functional starter compounds (“starters”) has been the subject of intensive study for more than 40 years (e.g. Inoue et al., Copolymerization of Carbon Dioxide and Epoxide with Organometallic Compounds; Die Makromolekulare Chemie 130, 210-220, 1969). This reaction is shown in schematic form in scheme (I), where R is an organic radical such as alkyl, alkylaryl or aryl, each of which may also contain heteroatoms, for example O, S, Si, etc., and where e, f and g are each integers, and where the product shown here in scheme (I) for the polyether carbonate polyol should merely be understood in such a way that blocks having the structure shown may in principle be present in the polyether carbonate polyol obtained, but the sequence, number and length of the blocks and the OH functionality of the starter may vary, and it is not restricted to the polyether carbonate polyol shown in scheme (I). This reaction (see scheme (I)) is highly advantageous from an environmental standpoint since this reaction comprises converting a greenhouse gas such as CO₂ into a polymer. A further product formed, actually a by-product, is the cyclic carbonate shown in scheme (I) (for example propylene carbonate when R=CH₃, also referred to hereinafter as cPC, or ethylene carbonate when R=H, also referred to hereinafter as cEC).

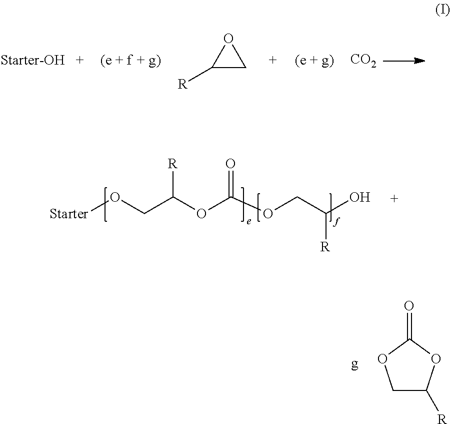

The production of polyurethane foams based on polyether carbonate polyols and isocyanates is known (e.g. WO2012/130760 A1, EP-A 0 222 453). It has been found that when polyether carbonate polyols are used for producing polyurethane foams, the resulting products contain cyclic propylene carbonate which can be detected, for example, by emission measurements on the flexible polyurethane foam.

WO 2016/097729 A1 describes that a reduction in the emission of cyclic propylene carbonate is observable through the use of oligomeric alkyl phosphates and esters of phosphoric acid as additives when foaming polyurethane foams. The possible use of alkoxylated phosphoric acid as an additive is also described.

### SUMMARY

It was an object of the present invention to provide a process for producing polyurethane foams which affords polyurethane foams having a reduced emission of cyclic propylene carbonate.

This object was surprisingly achieved by a process for producing polyurethane foams by reaction of the components
A polyol component, containing
   A1 40 to 100 parts by weight of polyether carbonate polyol having a hydroxyl number according to DIN 53240-1 (June 2013) of 20 mg KOH/g to 120 mg KOH/g
   A2 0 to 60 parts by weight of polyether polyol having a hydroxyl number according to DIN 53240-1 (June 2013) of 20 mg KOH/g to 250 mg KOH/g and a content of ethylene oxide of 0% to 60% by weight, wherein polyether polyol A2 is free from carbonate units,
B
   B1 catalyst, and
   B2 optionally auxiliary and additive substances,
C water and/or physical blowing agents,
with
D di- and/or polyisocyanates,
wherein production is carried out at an index of 90 to 120 and in the presence of a component K,
characterized in that the component K contains a reaction product of alkoxylated phosphoric acid with 1,3-dicarbonyl compound or carboxylic anhydride and was optionally alkoxylated in at least one subsequent step,
and the component K is employed in an amount of 0.05 to 10.00 parts by weight based on the sum of the parts by weight of components A1+A2=100 parts by weight.

The invention preferably provides a process for producing polyurethane foams, preferably flexible polyurethane foams, by reaction of
A1 40 to 100 parts by weight, preferably 60 to 100 parts by weight, particularly preferably 80 to 100 parts by weight, of one or more polyether carbonate polyols having a hydroxyl number according to DIN 53240-1 (June 2013) of 20 mg KOH/g to 120 mg KOH/g,
A2 0 to 60 parts by weight, preferably 0 to 40 parts by weight, particularly preferably 0 to 20 parts by weight, of one or more polyether polyols having a hydroxyl number according to DIN 53240-1 (June 2013) of 20 mg KOH/g to 250 mg KOH/g and a content of ethylene oxide of 0% to 60% by weight, wherein the polyether polyols A2 are free from carbonate units,
A3 0 to 20 parts by weight, based on the sum of the parts by weight of the components A1 and A2, of one or more polyether polyols having a hydroxyl number according to DIN 53240-1 (June 2013) of 20 mg KOH/g to 250 mg KOH/g and a content of ethylene oxide of >60% by weight, wherein the polyether polyols A3 are free from carbonate units,
A4 0 to 40 parts by weight, based on the sum of the parts by weight of the components A1 and A2, of one or more polymer polyols, PUD polyols and/or PIPA polyols,
A5 0 to 40 parts by weight, based on the sum of the parts by weight of the components A1 and A2, of polyols which do not fall under the definition of the components A1 to A4,
B
   B1 catalyst, and
   B2 optionally auxiliary and additive substances,
C water and/or physical blowing agents,
with
D di- and/or polyisocyanates,
wherein production is carried out at an index of 90 to 120, and
wherein the reported parts by weight of the components A3, A4 and A5 are in each case based on the sum of the parts by weight of A1+A2=100 parts by weight.

The components A1 to A5 in each case relate to “one or more” of the recited compounds. Where a plurality of compounds is used for one component, the stated amount corresponds to the sum of the parts by weight of the compounds.

In a particularly preferred embodiment component A contains
A1 65 to 75 parts by weight, most preferably 68 to 72 parts by weight, of one or more polyether carbonate polyols having a hydroxyl number according to DIN 53240-1 (June 2013) of 20 mg KOH/g to 120 mg KOH/g and preferably a CO₂ content of 15% to 25% by weight, and
A2 25 to 35 parts by weight, most preferably 28 to 32 parts by weight, of one or more polyether polyols having a hydroxyl number according to DIN 53240-1 (June 2013) of 20 mg KOH/g to 250 mg KOH/g and a content of ethylene oxide of 0% to 60% by weight, wherein the polyether polyols A2 are free from carbonate units,

wherein the component A is preferably free from component A3 and/or A4.

In another embodiment component A comprises
A1 65 to 75 parts by weight, preferably 68 to 72 parts by weight, of one or more polyether carbonate polyols having a hydroxyl number according to DIN 53240-1 (June 2013) of 20 mg KOH/g to 120 mg KOH/g and preferably a CO₂ content of 15% to 25% by weight, and
A2 25 to 35 parts by weight, preferably 28 to 32 parts by weight, of one or more polyether polyols having a hydroxyl number according to DIN 53240-1 (June 2013) of 20 mg KOH/g to 250 mg KOH/g and a content of ethylene oxide of 0% to 60% by weight, wherein the polyether polyols A2 are free from carbonate units,
A3 2 to 20 parts by weight, preferably 2 to 10 parts by weight, based on the sum of the parts by weight of the components A1 and A2, of one or more polyether polyols having a hydroxyl number according to DIN 53240-1 (June 2013) of 20 mg KOH/g to 250 mg KOH/g and a content of ethylene oxide of >60% by weight, wherein the polyether polyols A3 are free from carbonate units,

wherein the component A is preferably free from component A4.

In a further embodiment component A comprises
A1 40 to 100 parts by weight, preferably 60 to 100 parts by weight, particularly preferably 80 to 100 parts by weight, most preferably 65 to 75 parts by weight, of one or more polyether carbonate polyols having a hydroxyl number according to DIN 53240-1 (June 2013) of 20 mg KOH/g to 120 mg KOH/g and preferably a CO₂ content of 15% to 25% by weight, and
A2 0 to 60 parts by weight, preferably 0 to 40 parts by weight, particularly preferably 0 to 20 parts by weight, most preferably 25 to 35 parts by weight, of one or more polyether polyols having a hydroxyl number according to DIN 53240-1 (June 2013) of 20 mg KOH/g to 250 mg KOH/g and a content of ethylene oxide of 0% to 60% by weight, wherein the polyether polyols A2 are free from carbonate units,
A4 0.01 to 40.00 parts by weight, preferably 0.01 to 20.00 parts by weight, particularly preferably 1.00 to 20.00 parts by weight, most preferably 2.00 to 20.00 parts by weight, based on the sum of the parts by weight of the components A1 and A2, of one or more polymer polyols, PUD polyols and/or PIPA polyols,
A5 0 to 40 parts by weight, based on the sum of the parts by weight of the components A1 and A2, of polyols which do not fall under the definition of the components A1 to A4,

wherein component A is preferably free from component A3.

The reported ranges and preferred ranges for components A1, A2, A4, and A5 may be freely combined with one another.

The components used in the process according to the invention are described in more detail hereinbelow.

### DETAILED DESCRIPTION

Component A1

The component A1 comprises a polyether carbonate polyol which has a hydroxyl number (OH number) according to DIN 53240-1 (June 2013) of 20 mg KOH/g to 120 mg KOH/g, preferably of 20 mg KOH/g to 100 mg KOH/g, particularly preferably of 25 mg KOH/g to 90 mg KOH/g, and is obtainable by copolymerization of carbon dioxide and one or more alkylene oxides in the presence of one or more H-functional starter molecules, wherein the polyether carbonate polyol preferably has a CO₂ content of 15% to 25% by weight. Component A1 preferably comprises a polyether carbonate polyol obtainable by copolymerization of 2% by weight to 30% by weight of carbon dioxide and 70% by weight to 98% by weight of one or more alkylene oxides in the presence of one or more H-functional starter molecules having an average functionality of 1 to 6, preferably of 1 to 4, particularly preferably of 2 to 3. “H-functional” is to be understood in the context of the invention as meaning a starter compound having alkoxylation-active H atoms.

The copolymerization of carbon dioxide and one or more alkylene oxides is preferably effected in the presence of at least one DMC catalyst (double metal cyanide catalyst).

The polyether carbonate polyols used according to the invention preferably also comprise ether groups between the carbonate groups as shown schematically in formula (II). In the scheme according to formula (II), R is an organic radical such as alkyl, alkylaryl or aryl which may in each case also contain heteroatoms such as O, S, Si, etc., and e and f are each an integer. The polyether carbonate polyol shown in the scheme according to formula (II) should be understood as meaning merely that blocks having the structure shown may in principle be present in the polyether carbonate polyol, but the sequence, number and length of the blocks may vary and is not restricted to the polyether carbonate polyol shown in formula (II). In the case of formula (II), this means that the ratio of e/f is preferably from 2:1 to 1:20, particularly preferably from 1.5:1 to 1:10.

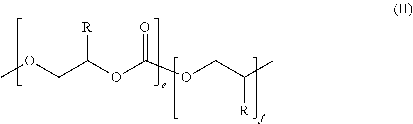

The proportion of incorporated CO₂ (“units derived from carbon dioxide”; “CO₂ content”) in a polyether carbonate polyol can be determined from the evaluation of characteristic signals in the ¹H NMR spectrum. The example below illustrates the determination of the proportion of units derived from carbon dioxide in an octane-1,8-diol-started CO₂/propylene oxide polyether carbonate polyol.

The proportion of incorporated CO₂ in a polyether carbonate polyol and the ratio of propylene carbonate to polyether carbonate polyol may be determined by ¹H NMR (a suitable instrument is the DPX 400 instrument from Bruker, 400 MHz; pulse program zg30, delay time dl: 10 s, 64 scans). Each sample is dissolved in deuterated chloroform. The relevant resonances in the ¹H NMR (based on TMS=0 ppm) are as follows:

Cyclic propylene carbonate (formed as a by-product) having a resonance at 4.5 ppm, carbonate resulting from carbon dioxide incorporated in the polyether carbonate polyol having resonances at 5.1 to 4.8 ppm, unreacted propylene oxide (PO) having a resonance at 2.4 ppm, polyether polyol (i.e. without incorporated carbon dioxide) having resonances at 1.2 to 1.0 ppm, the octane-1,8-diol incorporated as starter molecule (if present) having a resonance at 1.6 to 1.52 ppm.

The proportion by weight (in % by weight) of polymer-bound carbonate (LC′) in the reaction mixture was calculated by formula (III)

$${LC}^{′} = \frac{[ A ( 5.1 - 4.8 ) - A ( 4.5 ) ] * 102}{D} * 100 \% \qquad ( III )$$

where the value of D (“denominator” D) is calculated by formula (IV):

D=[A(5.1−4.8)−A(4.5)]*102+A(4.5)*102+A(2.4)*58−0.33*A(1.2−1.0)*58+0.25*A(1.6−1.52)*146 (IV)

The following abbreviations are used here:

A(4.5)=area of the resonance at 4.5 ppm for cyclic carbonate (corresponds to an H atom)

A(5.1−4.8)=area of the resonance at 5.1 to 4.8 ppm for polyether carbonate polyol and an H atom for cyclic carbonate.

A(2.4)=area of the resonance at 2.4 ppm for free, unreacted PO

A(1.2−1.0)=area of the resonance at 1.2 to 1.0 ppm for polyether polyol

A(1.6−1.52)=area of the resonance at 1.6 to 1.52 ppm for octane-1,8-diol (starter), if present.

The factor of 102 results from the sum of the molar masses of CO₂ (molar mass 44 g/mol) and of propylene oxide (molar mass 58 g/mol), the factor of 58 results from the molar mass of propylene oxide, and the factor of 146 results from the molar mass of the octane-1,8-diol starter used (if present).

The proportion by weight (in % by weight) of cyclic carbonate (CC′) in the reaction mixture was calculated by formula (V):

$${CC}^{′} = \frac{A ( 4.5 ) * 102}{D} * 100 \% \qquad ( V )$$

where the value of D is calculated by formula (IV).

In order to calculate the composition based on the polymer component (consisting of polyether polyol formed from starter and propylene oxide during the activation steps that take place in the absence of CO₂ and polyether carbonate polyol formed from starter, propylene oxide, and carbon dioxide during the activation steps that take place in the presence of CO₂ and during the copolymerization) from the values for the composition of the reaction mixture, the non-polymeric constituents of the reaction mixture (i.e. cyclic propylene carbonate and any unreacted propylene oxide present) were mathematically eliminated. The weight fraction of repeating carbonate units in the polyether carbonate polyol was converted to a weight fraction of carbon dioxide by application of the factor F=44/(44+58). The value for the CO₂ content in the polyether carbonate polyol is normalized to the proportion of the polyether carbonate polyol molecule which was formed in the copolymerization and in any activation steps in the presence of CO₂ (i.e. the proportion of the polyether carbonate polyol molecule resulting from the starter (octane-1,8-diol, if present) and from the reaction of the starter with epoxide which was added under CO₂-free conditions was not taken into account here).

For example, the preparation of polyether carbonate polyols of A1 comprises:
(α) initially charging an H-functional starter compound or a mixture of at least two H-functional starter compounds and optionally removing water and/or other volatile compounds by means of elevated temperature and/or reduced pressure (“drying”), wherein the DMC catalyst is added to the H-functional starter compound or to the mixture of at least two H-functional starter compounds before or after drying,
(β) adding a partial amount (based on the total amount of the amount of alkylene oxides used in the activation and copolymerization) of one or more alkylene oxides to the mixture resulting from step (α) to effect activation, wherein this addition of a partial amount of alkylene oxide may optionally be carried out in the presence of CO₂, and wherein there is then a wait in each case for the hot spots that arise as a result of the ensuing exothermic chemical reaction and/or for a decrease in the pressure in the reactor, and wherein the activation step (β) may also be carried out multiple times,
(γ) adding one or more of the alkylene oxides and carbon dioxide to the mixture resulting from step (α), wherein the alkylene oxides used in step (β) may be identical or different to the alkylene oxides used in step (γ).

Preparation of the polyether carbonate polyols A1 may generally be achieved using alkylene oxides (epoxides) having 2 to 24 carbon atoms. The alkylene oxides having from 2 to 24 carbon atoms are for example one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, monoepoxidized or polyepoxidized fats as monoglycerides, diglycerides and triglycerides, epoxidized fatty acids, Cr C₂₄ esters of epoxidized fatty acids, epichlorohydrin, glycidol, and derivatives of glycidol, for example methyl glycidyl ether, ethyl glycidyl ether, 2-ethylhexyl glycidyl ether, allyl glycidyl ether, glycidyl methacrylate and epoxy-functional alkoxysilanes, for example 3-glycidyloxypropyltrimethoxysilane, 3-glycidyloxypropyltriethoxysilane, 3-glycidyloxypropyltripropoxysilane, 3-glycidyloxypropylmethyldimethoxysilane, 3-glycidyloxypropylethyldiethoxysilane, 3-glycidyloxypropyltriisopropoxysilane. Preference is given to using ethylene oxide and/or propylene oxide and/or 1,2-butylene oxide, particularly preferably propylene oxide, as alkylene oxides.

In a preferred embodiment of the invention the proportion of ethylene oxide in the altogether employed amount of propylene oxide and ethylene oxide is 0% to 90% by weight, preferably 0% to 50% by weight and particularly preferably free from ethylene oxide.

Suitable H-functional starter compounds that may be employed include compounds having alkoxylation-active H atoms. Alkoxylation-active groups having active H atoms are, for example, —OH, —NH₂ (primary amines), —NH— (secondary amines), —SH, and —CO₂H, preferably —OH and —NH₂, particularly preferably —OH. Employed H-functional starter compounds include, for example, one or more compounds selected from the group consisting of water, mono- or polyhydric alcohols, polyfunctional amines, polyhydric thiols, amino alcohols, thio alcohols, hydroxy esters, polyether polyols, polyester polyols, polyester ether polyols, polyether carbonate polyols, polycarbonate polyols, polycarbonates, polyethyleneimines, polyetheramines (for example the products called Jeffamines® from Huntsman, for example D-230, D-400, D-2000, T-403, T-3000, T-5000 or corresponding BASF products, for example Polyetheramine D230, D400, D200, T403, T5000), polytetrahydrofurans (e.g. PolyTHF® from BASF, for example PolyTHF® 250, 650S, 1000, 1000S, 1400, 1800, 2000), polytetrahydrofuranamines (BASF product Polytetrahydrofuranamine 1700), polyether thiols, polyacrylate polyols, castor oil, the mono- or diglyceride of ricinoleic acid, monoglycerides of fatty acids, chemically modified mono-, di- and/or triglycerides of fatty acids, and C₁-C₂₄-alkyl fatty acid esters containing an average of at least 2 OH groups per molecule. The C₁-C₂₄ alkyl fatty acid esters containing an average of at least 2 OH groups per molecule are for example commercial products such as Lupranol Balance® (from BASF AG), Merginol® products (from Hobum Oleochemicals GmbH), Sovermol® products (from Cognis Deutschland GmbH & Co. KG) and Soyol®TM products (from USSC Co.).

Employable monofunctional starter compounds include alcohols, amines, thiols and carboxylic acids. Monofunctional alcohols that may be used include: methanol, ethanol, 1-propanol, 2-propanol, 1-butanol, 2-butanol, t-butanol, 3-buten-1-ol, 3-butyn-1-ol, 2-methyl-3-buten-2-ol, 2-methyl-3-butyn-2-ol, propargyl alcohol, 2-methyl-2-propanol, 1-t-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, phenol, 2-hydroxybiphenyl, 3-hydroxybiphenyl, 4-hydroxybiphenyl, 2-hydroxypyridine, 3-hydroxypyridine, 4-hydroxypyridine. Suitable monofunctional amines include: butylamine, t-butylamine, pentylamine, hexylamine, aniline, aziridine, pyrrolidine, piperidine, morpholine. Monofunctional thiols that may be used include: ethanethiol, 1-propanethiol, 2-propanethiol, 1-butanethiol, 3-methyl-1-butanethiol, 2-butene-1-thiol, thiophenol. Monofunctional carboxylic acids include: formic acid, acetic acid, propionic acid, butyric acid, fatty acids such as stearic acid, palmitic acid, oleic acid, linoleic acid, linolenic acid, benzoic acid, acrylic acid.

Polyhydric alcohols suitable as H-functional starter compounds include for example dihydric alcohols (for example ethylene glycol, diethylene glycol, propylene glycol, dipropylene glycol, propane-1,3-diol, butane-1,4-diol, butene-1,4-diol, butyne-1,4-diol, neopentyl glycol, pentantane-1,5-diol, methylpentanediols (for example 3-methylpentane-1,5-diol), hexane-1,6-diol; octane-1,8-diol, decane-1,10-diol, dodecane-1,12-diol, bis(hydroxymethyl)cyclohexanes (for example 1,4-bis(hydroxymethyl)cyclohexane), triethylene glycol, tetraethylene glycol, polyethylene glycols, dipropylene glycol, tripropylene glycol, polypropylene glycols, dibutylene glycol, and polybutylene glycols); trihydric alcohols (for example trimethylolpropane, glycerol, trishydroxyethyl isocyanurate, castor oil); tetrahydric alcohols (for example pentaerythritol); polyalcohols (for example sorbitol, hexitol, sucrose, starch, starch hydrolyzates, cellulose, cellulose hydrolyzates, hydroxy-functionalized fats and oils, especially castor oil), and also all products of modification of these abovementioned alcohols having different amounts of ε-caprolactone. Also employable in mixtures of H-functional starters are trihydric alcohols, for example trimethylolpropane, glycerol, trishydroxyethyl isocyanurate, and castor oil.

The H-functional starter compounds can also be selected from the class of polyether polyols, in particular those having a molecular weight Mₙ in the range from 100 to 4000 g/mol, preferably from 250 to 2000 g/mol. Preference is given to polyether polyols constructed from repeating ethylene oxide and propylene oxide units, preferably having a proportion of propylene oxide units of from 35% to 100%, particularly preferably having a proportion of propylene oxide units of from 50% to 100%. These may be random copolymers, gradient copolymers, alternating copolymers or block copolymers of ethylene oxide and propylene oxide. Suitable polyether polyols constructed from repeating propylene oxide and/or ethylene oxide units are, for example, the Desmophen®, Acclaim®, Arcol®, Baycoll®, Bayfill®, Bayflex®, Baygal®, PET® and polyether polyols from Covestro Deutschland AG (for example Desmophen® 3600Z, Desmophen® 1900U, Acclaim® Polyol 2200, Acclaim® Polyol 4000, Arcol® Polyol 1004, Arcol® Polyol 1010, Arcol Polyol 1030, Arcol® Polyol 1070, Baycoll® BD 1110, Bayfill® VPPU 0789, Baygal® K55, PET® 1004, Polyether® S180). Further suitable homopolyethylene oxides are, for example, the Pluriol® E products from BASF SE, suitable homopolypropylene oxides are, for example, the Pluriol® P products from BASF SE; suitable mixed copolymers of ethylene oxide and propylene oxide are, for example, the Pluronic® PE or Pluriol® RPE products from BASF SE.

The H-functional starter compounds can also be selected from the class of polyester polyols, in particular those having a molecular weight Mₙ in the range from 200 to 4500 g/mol, preferably from 400 to 2500 g/mol. The polyester polyols used are at least difunctional polyesters. Polyester polyols preferably consist of alternating acid and alcohol units. Acid components employed include, for example, succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride or mixtures of the acids and/or anhydrides mentioned. Alcohol components employed include, for example, ethanediol, propane-,2-diol, propane-1,3-diol, butane-1,4-diol, pentane-1,5-diol, neopentyl glycol, hexane-1,6-diol, 1,4-bis(hydroxymethyl)cyclohexane, diethylene glycol, dipropylene glycol, trimethylolpropane, glycerol, pentaerythritol or mixtures of the alcohols mentioned. Employing dihydric or polyhydric polyether polyols as the alcohol component affords polyester ether polyols which can likewise serve as starter compounds for preparing the polyether carbonate polyols. If polyether polyols are used to prepare the polyester ether polyols, preference is given to polyether polyols having a number-average molecular weight M. of 150 to 2000 g/mol.

In addition, the H-functional starter compounds used may be polycarbonate polyols (for example polycarbonate diols), especially those having a molecular weight Mₙ in the range from 150 to 4500 g/mol, preferably 500 to 2500, which are prepared, for example, by reaction of phosgene, dimethyl carbonate, diethyl carbonate or diphenyl carbonate and di- and/or polyfunctional alcohols or polyester polyols or polyether polyols. Examples of polycarbonate polyols may be found in EP-A 1359177 for example. For example, the Desmophen® C products from Covestro Deutschland AG, for example Desmophen® C 1100 or Desmophen® C 2200, may be used as polycarbonate diols. Likewise employable as H-functional starter compounds are polyether carbonate polyols. Polyether carbonate polyols prepared by the process described hereinabove are used in particular. To this end these polyether carbonate polyols used as H-functional starter compounds are prepared in a separate reaction step beforehand.

Preferred H-functional starter compounds are alcohols of general formula (VI)

HO—(CH₂)ₓ—OH (VI),

wherein x is a number from 1 to 20, preferably an integer from 2 to 20. Examples of alcohols of formula (VI) are ethylene glycol, butane-1,4-diol, hexane-1,6-diol, octane-1,8-diol, decane-1,10-diol, and dodecane-1,12-diol. Further preferred H-functional starter compounds are neopentyl glycol, trimethylolpropane, glycerol, pentaerythritol, reaction products of the alcohols of formula (VI) with ε-caprolactone, for example reaction products of trimethylolpropane with ε-caprolactone, reaction products of glycerol with ε-caprolactone, and reaction products of pentaerythritol with ε-caprolactone. Likewise preferably employed as H-functional starter compounds are water, diethylene glycol, dipropylene glycol, castor oil, sorbitol, and polyether polyols constructed from repeating polyalkylene oxide units.

It is particularly preferable when the H-functional starter compounds are one or more compounds selected from the group consisting of ethylene glycol, propylene glycol, 1,3-propanediol, 1,3-butanediol, 1,4-butanediol, 1,5-pentanediol, 2-methylpropane-1,3-diol, neopentyl glycol, 1,6-hexanediol, diethylene glycol, dipropylene glycol, glycerol, trimethylolpropane, di- and trifunctional polyether polyols, wherein the polyether polyol is constructed from a di- or tri-H-functional starter compound and propylene oxide or a di- or tri-H-functional starter compound, propylene oxide and ethylene oxide. The polyether polyols preferably have a number-average molecular weight Mₙ in the range from 62 to 4500 g/mol and in particular a number-average molecular weight Mₙ in the range from 62 to 3000 g/mol, very particularly preferably a molecular weight of 62 to 1500 g/mol. The polyether polyols preferably have a functionality of 2 to 3.

In a preferred embodiment of the invention the polyether carbonate polyol A1 is obtainable by addition of carbon dioxide and alkylene oxides to H-functional starter compounds using multimetal cyanide catalysts (DMC catalysts). The preparation of polyether carbonate polyols by addition of alkylene oxides and CO₂ onto H-functional starter compounds using DMC catalysts is known, for example, from EP-A 0222453, WO-A 2008/013731 and EP-A 2115032.

DMC catalysts are known in principle from the prior art for the homopolymerization of epoxides (see, for example, U.S. Pat. Nos. 3,404,109, 3,829,505, 3,941,849 and 5,158,922). DMC catalysts described, for example, in U.S. Pat. No. 5,470,813, EP-A 700 949, EP-A 743 093, EP-A 761 708, WO-A 97/40086, WO-A 98/16310, and WO-A 00/47649 have very high activity in the homopolymerization of epoxides and make it possible to prepare polyether polyols and/or polyether carbonate polyols at very low catalyst concentrations (25 ppm or less). A typical example is the highly active DMC catalysts described in EP-A 700 949 which in addition to a double metal cyanide compound (e.g., zinc hexacyanocobaltate (III)) and an organic complexing ligand (e.g., t-butanol) contain a polyether having a number-average molecular weight M. of greater than 500 g/mol.

The DMC catalyst is usually employed in an amount of <1 wt %, preferably in an amount of <0.5 wt %, particularly preferably in an amount of <500 ppm and in particular in an amount of <300 ppm, in each case based on the weight of the polyether carbonate polyol.

In a preferred embodiment of the invention the polyether carbonate polyol A1 has a content of carbonate groups (“units derived from carbon dioxide”), calculated as CO₂, of 2.0% and 30.0% by weight, preferably of 5.0% and 28.0% by weight and particularly preferably of 10.0% and 25.0% by weight.

In a further embodiment of the process according to the invention the polyether carbonate polyol(s) of A1 have a hydroxyl number of 20 mg KOH/g to 250 mg KOH/g and are obtainable by copolymerization of 2.0% by weight to 30.0% by weight of carbon dioxide and 70% by weight to 98% by weight of propylene oxide in the presence of a hydroxy-functional starter molecule, for example trimethylolpropane and/or glycerol and/or propylene glycol and/or sorbitol. The hydroxyl number can be determined in accordance with DIN 53240-1 (June 2013).

In a further embodiment a polyether carbonate polyol A1 containing blocks of formula (II) is employed, wherein the ratio e/f is from 2:1 to 1:20.

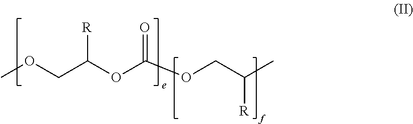

In a further embodiment of the invention component A1 is employed to an extent of 100 parts by weight.

Component A2

The component A2 comprises polyether polyols having a hydroxyl number according to DIN 53240-1 (June 2013) of 20 mg KOH/g to 250 mg KOH/g, preferably of 20 to 112 mg KOH/g and particularly preferably 20 mg KOH/g to 80 mg KOH/g and is free from carbonate units. The compounds according to A2 may be prepared by catalytic addition of one or more alkylene oxides onto H-functional starter compounds.

Employable alkylene oxides (epoxides) include alkylene oxides having 2 to 24 carbon atoms. The alkylene oxides having from 2 to 24 carbon atoms are, for example, one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, monoepoxidized or polyepoxidized fats as monoglycerides, diglycerides and triglycerides, epoxidized fatty acids, C₁-C₂₄ esters of epoxidized fatty acids, epichlorohydrin, glycidol, and derivatives of glycidol, for example methyl glycidyl ether, ethyl glycidyl ether, 2-ethylhexyl glycidyl ether, allyl glycidyl ether, glycidyl methacrylate and epoxy-functional alkoxysilanes, for example 3-glycidyloxypropyltrimethoxysilane, 3-glycidyloxypropyltriethoxysilane, 3-glycidyloxypropyltripropoxysilane, 3-glycidyloxypropylmethyldimethoxysilane, 3-glycidyloxypropylethyldiethoxysilane, 3-glycidyloxypropyltriisopropoxysilane. Preferably employed alkylene oxides are ethylene oxide and/or propylene oxide and/or 1,2-butylene oxide. Particular preference is given to using an excess of propylene oxide and/or 1,2-butylene oxide. The alkylene oxides may be introduced into the reaction mixture individually, in admixture or successively. The copolymers may be random or block copolymers. If the alkylene oxides are added successively, the products (polyether polyols) prepared contain polyether chains having block structures.

The H-functional starter compounds have functionalities of 2 to 6 and are preferably hydroxy-functional (OH-functional). Examples of hydroxy-functional starter compounds are propylene glycol, ethylene glycol, diethylene glycol, dipropylene glycol, butane-1,2-diol, butane-1,3-diol, butane-1,4-diol, hexanediol, pentanediol, 3-methylpentane-1,5-diol, dodecane-1,12-diol, glycerol, trimethylolpropane, triethanolamine, pentaerythritol, sorbitol, sucrose, hydroquinone, catechol, resorcinol, bisphenol F, bisphenol A, 1,3,5-trihydroxybenzene, methylol group-containing condensates of formaldehyde and phenol or melamine or urea. These may also be used in admixture. The starter compound used is preferably 1,2-propylene glycol and/or glycerol and/or trimethylolpropane and/or sorbitol.

The polyether polyols A2 have a content of 0% to 60% by weight, preferably of 0% to 40% by weight, particularly preferably 0% to 25% by weight, of ethylene oxide.

Component A3

The component A3 comprises polyether polyols having a hydroxyl number according to DIN 53240-1 (June 2013) of 20 mg KOH/g to 250 mg KOH/g, preferably of 20 to 112 mg KOH/g and particularly preferably 20 mg KOH/g to 80 mg KOH/g.

The production of component A3 is in principle carried out analogously to that of component A2 with the exception that a content of ethylene oxide in the polyether polyol of >60% by weight, preferably >65% by weight, is established.

Suitable alkylene oxides and H-functional starter compounds include the same compounds as described for component A2.

However, suitable H-functional starter compounds are preferably those having a functionality of 3 to 6, particularly preferably of 3, so that polyether triols are formed. Preferred H-functional starter compounds having a functionality of 3 are glycerol and/or trimethylolpropane, glycerol being particularly preferred.

In a preferred embodiment component A3 is a glycerol-started trifunctional polyether having an ethylene oxide content of 68% to 73% by weight and an OH number of 35 to 40 mg KOH/g.

Component A4

The component A4 comprises polymer polyols, PUD polyols, and PIPA polyols.

Polymer polyols are polyols which contain proportions of solid polymers produced by free-radical polymerization of suitable monomers such as styrene or acrylonitrile in a base polyol, for example a polyether polyol and/or polyether carbonate polyol.

PUD (polyurea dispersion) polyols are produced for example by in-situ polymerization of an isocyanate or an isocyanate mixture with a diamine and/or hydrazine in a polyol, preferably a polyether polyol. The PUD dispersion is preferably prepared by reacting an isocyanate mixture employed of a mixture of 75% to 85% by weight of tolylene 2,4-diisocyanate (2,4-TDI) and 15% to 25% by weight of tolylene 2,6-diisocyanate (2,6-TDI) with a diamine and/or hydrazine in a polyether polyol, preferably a polyether polyol and/or polyether carbonate polyol, prepared by alkoxylation of a trifunctional starter (for example glycerol and/or trimethylolpropane), in the case of the polyether carbonate polyol in the presence of carbon dioxide. Processes for preparing PUD dispersions are described, for example, in U.S. Pat. Nos. 4,089,835 and 4,260,530.

PIPA polyols are polyether polyols and/or polyether carbonate polyols modified with alkanolamines, preferably modified with triethanolamine, by polyisocyanate polyaddition, wherein the polyether (carbonate) polyol has a functionality of 2.5 to 4.0 and a hydroxyl number of 3 mg KOH/g to 112 mg KOH/g (molecular weight 500 to 18 000 g/mol). The polyether polyol is preferably “EO capped”, i.e. the polyether polyol has terminal ethylene oxide groups. PIPA polyols are described in detail in GB 2 072 204 A, DE 31 03 757 A1 and U.S. Pat. No. 4,374,209 A.

Component A5

Employable components A5 include all polyhydroxy compounds known to those skilled in the art which do not fall under the definition of the components A1 to A4 and preferably have an average OH functionality of >1.5.

These may be, for example, low molecular weight diols (e.g. ethane-1,2-diol, propane-1,3- or -1,2-diol, butane-1,4-diol), triols (e.g. glycerol, trimethylolpropane) and tetraols (e.g. pentaerythritol), polyester polyols, polythioether polyols or polyacrylate polyols or else polyether polyols or polycarbonate polyols which do not fall under the definition of components A1 to A4. It is also possible to use, for example, ethylenediamine- and triethanolamine-started polyethers. These compounds are not counted as compounds according to the definition of component B2.

Component B

Preferably employed catalysts of the component B1 are
a) aliphatic tertiary amines (for example trimethylamine, tetramethylbutanediamine, 3-dimethylaminopropylamine, N,N-bis(3-dimethylaminopropyl)-N-isopropanolamine), cycloaliphatic tertiary amines (for example 1,4-diaza[2.2.2]bicyclooctane), aliphatic amino ethers (for example bis(dimethylaminoethyl) ether, 2-(2-dimethylaminoethoxy)ethanol and N,N,N-trimethyl-N-hydroxyethyl(bisaminoethyl ether)), cycloaliphatic amino ethers (for example N-ethylmorpholine), aliphatic amidines, cycloaliphatic amidines, urea and derivatives of urea (for example aminoalkylureas, see, for example, EP-A 0 176 013, in particular (3-dimethylaminopropylamine)urea) and/or
b) tin(II) salts of carboxylic acids.

The tin(II) salts of carboxylic acids are especially employed, wherein the parent carboxylic acid in each case has from 2 to 24 carbon atoms. Employed tin(J salts of carboxylic acids are, for example, one or more compounds selected from the group consisting of the tin(II) salt of 2-ethylhexanoic acid (i.e. tin(II) 2-ethylhexanoate or tin octoate), the tin(II) salt of 2-butyloctanoic acid, the tin(II) salt of 2-hexyldecanoic acid, the tin(II) salt of neodecanoic acid, the tin(II) salt of isononanoic acid, the tin(II) salt of oleic acid, the tin(II) salt of ricinoleic acid, and tin(II) laurate.

In a preferred embodiment of the invention at least one tin(II) salt of formula (VII)

Sn(CₓH₂ₓ₊₁COO)₂ (VII)

is used, wherein x is an integer from 8 to 24, preferably 10 to 20, particularly preferably from 12 to 18. In formula (VII) the alkyl chain CₓH₂ₓ₊₁ of the carboxylate is particularly preferably a branched carbon chain, i.e. CₓH₂ₓ₊₁ is an isoalkyl group.

Most preferably employed as tin(II) salts of carboxylic acids are one or more compounds selected from the group consisting of the tin(II) salt of 2-butyloctanoic acid, i.e. tin(II) 2-butyloctonate, the tin(II) salt of ricinoleic acid, i.e. tin(II) ricinoleate, and the tin(II) salt of 2-hexyldecanoic acid, i.e. tin(II) 2-hexyldecanoate.

In another preferred embodiment of the invention the component B1 employed comprises
B1.1 0.05 to 1.50 parts by weight, based on the sum of the parts by weight of the components A1 and A2, of urea and/or derivatives of urea and
B1.2 0.03 to 1.50 parts by weight, based on the sum of the parts by weight of components A1 and A2, of catalysts other than those of the component B1.2, wherein the content of amine catalysts in the component B1.2 is not more than 50% by weight based on component B1.

Component B1.1 comprises urea and derivatives of urea. Examples of derivatives of urea are: aminoalkylureas, e.g. (3-dimethylaminopropylamine)urea and 1,3-bis[3-(dimethylamino)propyl]urea. It is also possible to use mixtures of urea and urea derivatives. Preference is given to using exclusively urea in component B1.1. The component B1.1 is used in amounts of 0.05 to 1.50 parts by weight, preferably of 0.10 to 0.50 part by weight, particularly preferably of 0.25 to 0.35 part by weight, based on the sum of the parts by weight of the components A1 to A2.

The component B1.2 is used in amounts of 0.03 to 1.50 parts by weight, preferably 0.03 to 0.50 part by weight, particularly preferably of 0.10 to 0.30 part by weight, very particularly preferably of 0.20 to 0.30 part by weight, based on the sum of the parts by weight of the components A1 to A2.

The content of amine catalysts in component B1.2 is preferably not more than 50% by weight based on component B1.1, particularly preferably not more than 25% by weight based on component B1.1. Component B1.2 is very particularly preferably free of amine catalysts.

The above-described tin(II) salts of carboxylic acids, for example, can be used as catalysts of the component B1.2.

Amine catalysts for optional co-use in small amounts (see above) include: aliphatic tertiary amines (for example trimethylamine, tetramethylbutanediamine, 3-dimethylaminopropylamine, N,N-bis(3-dimethylaminopropyl)-N-isopropanolamine), cycloaliphatic tertiary amines (for example 1,4-diaza[2.2.2]bicyclooctane), aliphatic amino ethers (for example bis(dimethylaminoethyl) ether, 2-(2-dimethylaminoethoxy)ethanol and N,N,N-trimethyl-N-hydroxyethylbisaminoethyl ether), cycloaliphatic amino ethers (for example N-ethylmorpholine), aliphatic amidines, and cycloaliphatic amidines.

The “amine catalysts” recited in B1.2 do not include urea or derivatives thereof.

The invention therefore also provides a process for producing polyurethane foams by reaction of the components
A polyol component, containing
   A1 40 to 100 parts by weight of polyether carbonate polyol having a hydroxyl number according to DIN 53240-1 (June 2013) of 20 mg KOH/g to 120 mg KOH/g,
   A2 0 to 60 parts by weight of polyether polyol having a hydroxyl number according to DIN 53240-1 (June 2013) of 20 mg KOH/g to 250 mg KOH/g and a content of ethylene oxide of 0% to 60% by weight, wherein polyether polyol A2 is free from carbonate units,
in nonalkaline medium with
C water and/or physical blowing agents and
D di- and/or polyisocyanates,
wherein production is carried out at an index of 90 to 120 and in the presence of a component K.

The nonalkaline medium can preferably be achieved by using urea and/or derivatives of urea as catalysts of component B1 and not using any amine catalysts.

The invention therefore preferably provides a process for producing polyurethane foams, characterized in that
A polyol component, containing
   A1 40 to 100 parts by weight of polyether carbonate polyol having a hydroxyl number according to DIN 53240-1 (June 2013) of 20 mg KOH/g to 120 mg KOH/g,
   A2 0 to 60 parts by weight of polyether polyol having a hydroxyl number according to DIN 53240-1 (June 2013) of 20 mg KOH/g to 250 mg KOH/g and a content of ethylene oxide of 0% to 60% by weight, wherein polyether polyol A2 is free from carbonate units,
B1 in the presence of urea and/or derivatives of urea and in the absence of amine catalysts are reacted in nonalkaline medium with
C water and/or physical blowing agents and
D di- and/or polyisocyanates,
wherein production is carried out at an index of 90 to 120 and in the presence of a component K.

Employed as component B2 are auxiliary and additive substances, such as
a) surface-active additives, such as emulsifiers and foam stabilizers, especially those having low emission, for example products of the Tegostab® LF2 series,
b) additives such as reaction retardants (for example acidic substances such as hydrochloric acid or organic acyl halides), cell regulators (for example paraffins or fatty alcohols or dimethylpolysiloxanes), pigments, dyes, flame retardants, further stabilizers against aging and weathering effects, antioxidants, plasticizers, fungistatic and bacteriostatic substances, fillers (for example barium sulfate, kieselguhr, carbon black or whiting) and separating agents.

These auxiliary and additive substances for optional co-use are described for example in EP-A 0 000 389, pages 18-21. Further examples of auxiliary and additive substances for optional co-use according to the invention and also details concerning the ways these auxiliary and additive substances are employed and function are described in Kunststoff-Handbuch, volume VII, edited by G. Oertel, Carl-Hanser-Verlag, Munich, 3rd edition, 1993, for example on pages 104-127.

Component C

Water and/or physical blowing agents are employed as component C. Examples of physical blowing agents used as blowing agents are carbon dioxide and/or volatile organic substances. Preference is given to using water as component C.

Component D Suitable di- and/or polyisocyanates are aliphatic, cycloaliphatic, araliphatic, aromatic and heterocyclic polyisocyanates, such as, for example, by W. Siefken in Justus Liebigs Annalen der Chemie, 562, pages 75-136, for example those of formula (IX)

Q(NCO)ₙ (IX),

wherein
n is 2-4, preferably 2-3,

and
Q is an aliphatic hydrocarbon radical having 2-18, preferably 6-10, carbon atoms, a cycloaliphatic hydrocarbon radical having 4-15, preferably 6-13, carbon atoms or an araliphatic hydrocarbon radical having 8-15, preferably 8-13, carbon atoms.

These are, for example, polyisocyanates such as those described in EP-A 0 007 502, pages 7-8. Preference is generally given to the readily industrially obtainable polyisocyanates, for example tolylene 2,4- and 2,6-diisocyanate and any desired mixtures of these isomers (“TDI”); polyphenylpolymethylene polyisocyanates as prepared by aniline-formaldehyde condensation and subsequent phosgenation (“crude MDI”), and polyisocyanates having carbodiimide groups, urethane groups, allophanate groups, isocyanurate groups, urea groups or biuret groups (“modified polyisocyanates”), especially those modified polyisocyanates which are derived from tolylene 2,4- and/or 2,6-diisocyanate or from diphenylmethane 4,4′- and/or 2,4′-diisocyanate. Preference is given to using one or more compounds selected from the group consisting of tolylene 2,4- and 2,6-diisocyanate, diphenylmethane 4,4′- and 2,4′- and 2,2′-diisocyanate and polyphenylpolymethylene polyisocyanate (“multiring MDI”) as polyisocyanate. Particular preference is given to using tolylene 2,4- and/or 2,6-diisocyanate.

In a further embodiment of the process according to the invention the isocyanate component B comprises a tolylene diisocyanate isomer mixture composed of 55% to 90% by weight of 2,4-TDI and 10% to 45% by weight of 2,6-TDI.

In a further embodiment of the process according to the invention the isocyanate component D comprises 100% by weight of tolylene 2,4-diisocyanate.

In one embodiment of the process according to the invention the index is 90 to 120. The index is preferably in a range from 100 to 115, particularly preferably 102 to 110. The index specifies the percentage ratio of the actually employed isocyanate amount to the stoichiometric amount of isocyanate groups (NCO), i.e. the amount calculated for conversion of the OH equivalents.

Index=(isocyanate amount employed):(isocyanate amount calculated)·100 (XII)

Component K

According to the invention component K is a reaction product of an alkoxylated phosphoric acid with 1,3-dicarbonyl compound or carboxylic anhydride. Alkoxylated phosphoric acids are reaction products of phosphoric acid with the alkylene oxides described for component A1. Preferably employed alkylene oxides are ethylene oxide, propylene oxide or a mixture of ethylene oxide and propylene oxide, particularly preferably ethylene oxide. Alkoxylated phosphoric acid is preferably obtained by direct reaction of phosphoric acid with alkylene oxides without addition of a catalyst, wherein the phosphoric acid may be used in pure form or as aqueous solution (for example in the form of an 85% by weight solution).

According to the invention employable 1,3-dicarbonyl compounds include for example carboxylic acids having at least two carbonyl groups in 1,3 configuration, such as malonic acid or acetoacetic acid, esters of carboxylic acids having at least two carbonyl groups in 1,3 configuration, such as methylmalonate, ethylmalonate or acetoacetate, amides having at least two carbonyl groups in 1,3 configuration, such as acetoacetamide. Preferably employed 1,3-dicarbonyl compounds are esters of carboxylic acids having at least two carbonyl groups in 1,3 configuration, particularly preferably esters of malonic acid and/or acetoacetic acid.

Employable carboxylic anhydrides include for example phthalic anhydride, 1,2,3,6-tetrahydrophthalic anhydride, dodecenylsuccinic anhydride, citraconic anhydride or glutaric anhydride, wherein maleic anhydride and/or phthalic anhydride are preferably employed.

After the reaction of the alkoxylated phosphoric acid with 1,3-dicarbonyl compound or carboxylic anhydride component K may optionally be reacted with further alkylene oxide in one or more steps. The subsequent alkoxylation may be carried out for example at a temperature of at least 40° C., preferably at 40° C. to 140° C. and particularly preferably at 60° C. to 100° C. In one embodiment component K is subsequently
(1) initially charged into a reactor and reacted with alkylene oxide at 60° C. to 100° C. in an inert gas atmosphere (for example nitrogen or argon), and optionally
(2) volatile components are removed under vacuum at a temperature of 80° C. to 100° C.

Component K preferably has a hydroxyl number of 10 mg KOH/g to 320 mg KOH/g, particularly preferably 50 mg KOH/g to 300 mg KOH/g, particularly preferably 170 mg KOH/g to 300 mg KOH/g.

To produce the polyurethane foams, the reaction components are reacted by the single-step process known per se, often with the aid of mechanical devices, for example those described in EP-A 355 000. Details of processing apparatuses which are also suitable in accordance with the invention are described in Kunststoff-Handbuch, volume VII, edited by Vieweg and Höhtlen, Carl-Hanser-Verlag, Munich 1993, for example on pages 139 to 265.

The polyurethane foams are preferably in the form of flexible polyurethane foams and may be produced as molded foams or else as slabstock foams, preferably as slabstock foams. The invention therefore provides a process for producing the polyurethane foams, the polyurethane foams produced by these processes, the flexible polyurethane slabstock foams/flexible polyurethane molded foams produced by these processes, the use of the flexible polyurethane foams for production of moldings, and the moldings themselves.

The polyurethane foams, preferably flexible polyurethane foams, obtainable according to the invention are used for example in: furniture cushioning, textile inserts, mattresses, automotive seats, headrests, armrests, sponges, foam sheetings for use in automotive components, for example roof headlinings, door trim, seat covers and constructional elements.

The flexible foams according to the invention have an apparent density according to DIN EN ISO 3386-1-98 in the range from 16 to 60 kg/m³, preferably 20 to 50 kg/m³.

In a first embodiment the invention relates to a process for producing polyurethane foams by reacting the components
A polyol component, containing
   A1 40 to 100 parts by weight of polyether carbonate polyol having a hydroxyl number according to DIN 53240-1 (June 2013) of 20 mg KOH/g to 120 mg KOH/g,
   A2 0 to 60 parts by weight of polyether polyol having a hydroxyl number according to DIN 53240-1 (June 2013) of 20 mg KOH/g to 250 mg KOH/g and a content of ethylene oxide of 0% to 60% by weight, wherein polyether polyol A2 is free from carbonate units,
B
   B1 catalyst, and
   B2 optionally auxiliary and additive substances,
C water and/or physical blowing agents,
with
D di- and/or polyisocyanates,
wherein production is carried out at an index of 90 to 120 and in the presence of a component K,
characterized in that the component K contains a reaction product of alkoxylated phosphoric acid with 1,3-dicarbonyl compound or carboxylic anhydride and was optionally alkoxylated in at least one subsequent step,
and the component K is employed in an amount of 0.05 to 10.00 parts by weight based on the sum of the parts by weight of components A1+A2=100 parts by weight.

In a second embodiment the invention relates to a process according to the first embodiment, characterized in that the component A has the following composition:
A1 40 to 100 parts by weight of polyether carbonate polyol having a hydroxyl number according to DIN 53240-1 (June 2013) of 20 mg KOH/g to 120 mg KOH/g,
A2 0 to 60 parts by weight of polyether polyol having a hydroxyl number according to DIN 53240-1 (June 2013) of 20 mg KOH/g to 250 mg KOH/g and a content of ethylene oxide of 0% to 60% by weight, wherein polyether polyol A2 is free from carbonate units,
A3 0 to 20 parts by weight, based on the sum of the parts by weight of the components A1 and A2, of polyether polyol having a hydroxyl number according to DIN 53240-1 (June 2013) of 20 mg KOH/g to 250 mg KOH/g and a content of ethylene oxide of >60% by weight, wherein polyether polyol A3 is free from carbonate units,
A4 0 to 40 parts by weight, based on the sum of the parts by weight of the components A1 and A2, of polymer polyol, PUD polyol and/or PIPA polyol,
A5 0 to 40 parts by weight, based on the sum of the parts by weight of the components A1 and A2, of polyol which does not fall under the definition of the components A1 to A4,
wherein the reported parts by weight of the components A3, A4 and A5 are in each case based on the sum of the parts by weight of components A1+A2=100 parts by weight.

In a third embodiment the invention relates to a process according to the first or second embodiment, characterized in that component A is free from components A3 and/or A4.

In a fourth embodiment the invention relates to a process according to any of embodiments 1 to 3, characterized in that component A comprises:
A1 65 to 75 parts by weight of polyether carbonate polyol having a hydroxyl number according to DIN 53240-1 (June 2013) of 20 mg KOH/g to 120 mg KOH/g, and
A2 25 to 35 parts by weight of polyether polyol having a hydroxyl number according to DIN 53240-1 (June 2013) of 20 mg KOH/g to 250 mg KOH/g and a content of ethylene oxide of 0% to 60% by weight, wherein polyether polyol A2 is free from carbonate units.

In a fifth embodiment the invention relates to a process according to any of embodiments 1 to 4, characterized in that component A1 comprises a polyether carbonate polyol obtainable by copolymerization of carbon dioxide and alkylene oxide in the presence of H-functional starter molecules, wherein the polyether carbonate polyol preferably has a CO₂ content of 15% to 25% by weight.

In a sixth embodiment the invention relates to a process according to any of embodiments 1 to 5, characterized in that as component B
B1 catalyst selected from one or more of the following compounds
   a) aliphatic tertiary amines, cycloaliphatic tertiary amines, aliphatic amino ethers, cycloaliphatic amino ethers, aliphatic amidines, cycloaliphatic amidines, urea and derivatives of urea and/or
   b) tin(II) salts of carboxylic acids, and
B2 optionally auxiliary and additive substances
are employed.

In a seventh embodiment the invention relates to a process according to any of embodiments 1 to 5, characterized in that as component B
B1 catalyst and
B2 optionally auxiliary and additive substances
are employed,
wherein as component B1:
B1.1 0.05 to 1.50 parts by weight, based on the sum of the parts by weight of the components A1 and A2, of urea and/or derivatives of urea and
B1.2 0.03 to 1.50 parts by weight, based on the sum of the parts by weight of components A1 and A2, of catalyst other than those of the component B1.2, wherein the content of amine catalyst in the component B1.2 is not more than 50% by weight based on component B1,
is employed.

In an eighth embodiment the invention relates to a process according to any of embodiments 1 to 7, characterized in that component D contains 2,4- and/or 2,6-TDI.

In a ninth embodiment the invention relates to a process according to any of embodiments 1 to 8, characterized in that the component K contains a reaction product of alkoxylated phosphoric acid with a compound from the group consisting of acetoacetate ester, malonate ester, phthalic anhydride and maleic anhydride.

In a tenth embodiment the invention relates to a process according to any of embodiments 1 to 9, characterized in that the alkoxylated phosphoric acid is an ethoxylated phosphoric acid.

In an eleventh embodiment the invention relates to a process according to any of embodiments 1 to 10, characterized in that component K is employed in an amount of 0.5 to 6.0 parts by weight (based on the sum of the parts by weight of components A1+A2=100 parts by weight).

In a twelfth embodiment the invention relates to a process according to any of embodiments 1 to 11, characterized in that the component K was subsequently alkoxylated by
(1) initially charged into a reactor and reacted with alkylene oxide at 60° C. to 100° C. in an inert gas atmosphere,
and optionally
(2) volatile components are removed under vacuum at a temperature of 80° C. to 100° C.

In a thirteenth embodiment the invention relates to polyurethane foams obtainable by a process according to any of embodiments 1 to 12.

In a fourteenth embodiment the invention relates to polyurethane foams according to the thirteenth embodiment, wherein the foams are flexible polyurethane foams.

In a fifteenth embodiment the invention relates to the use of the polyurethane foams according to the thirteenth or fourteenth embodiment for producing furniture cushioning, textile inserts, mattresses, automotive seats, headrests, armrests, sponges, foam sheetings for use in automotive components, for example roof headlinings, door trim, seat covers and constructional elements.

In a sixteenth embodiment the invention relates to a process according to any of embodiments 1 to 8, characterized in that component K is a reaction product of alkoxylated phosphoric acid with 1,3-dicarbonyl compounds or a reaction product of alkoxylated phosphoric acid with carboxylic anhydrides and a subsequent alkoxylation step.

In a sixteenth embodiment the invention relates to a process according to any of the embodiments 1 to 12, characterized in that component K has a hydroxyl number of 10 mg KOH/g to 320 mg KOH/g, particularly preferably of 50 mg KOH/g to 300 mg KOH/g, especially preferably of 170 mg KOH/g to 300 mg KOH/g.

### Examples

Test Methods

Experimentally determined OH numbers (hydroxyl number) were determined according to the specification of DIN 53240-1 (June 2013).

Determination of Emissions—Cyclic Propylene Carbonate

The cPC content was quantified by means of ¹H NMR spectroscopy (Bruker, DPX 400, 400 MHz): about 24 h after production of the flexible polyurethane foams, a sample of 1.2-1.5 g of the flexible polyurethane foam was extracted at 60° C. in acetone using a Soxhlet apparatus for 7.5 hours. The extract was concentrated under reduced pressure and taken up in deuterated chloroform using dimethyl terephthalate or 1,2,4-trichlorobenzene as an internal standard. Subsequently, the cPC content was quantified by ¹H NMR by comparison with the internal standard.

The present invention will be illustrated with the aid of the following examples, but without being restricted thereto. Abbreviations:
A1-1: Polyether carbonate polyol, functionality 2.8, OH number 54 mg KOH/g, 14% by weight of CO₂, prepared by copolymerization of propylene oxide and carbon dioxide with glycerol and propylene glycol as H-functional starter compounds in the presence of a double metal cyanide catalyst
B1-1: Niax Catalyst A-1, bis[2-(N,N′-dimethylamino)ethyl]-based (Momentive Performance Materials GmbH)
B1-2: Desmorapid SO, tin catalyst (Covestro AG)
B2-1: Tegostab BF 2370 (Evonik Industries AG)
C-1: Water
D-1: Desmodur T 80, mixture of tolylene 2,4′-diisocyanate and tolylene 2,6′-diisocyanate in an 80/20 ratio (Covestro AG)

Preparation of the Alkoxylated Phosphoric Acid P-1:

255.5 g of polyphosphoric acid (85% by weight based on P₂O₅) and 47.3 g of water were initially charged in a 2 liter pressure reactor and heated to 80° C. After stirring for 1 hour (800 rpm) at 80° C. the pressure in the reactor was adjusted to 2.1 bar (absolute) using nitrogen. 1313 g of ethylene oxide were then metered into the reactor at 80° C. with stirring (800 rpm) at a metering rate of 300 g/h. After a postreaction time of 3 hours at 80° C., volatile components were distilled off at 90° C. under reduced pressure (10 mbar (absolute)) for 30 minutes and the reaction mixture was then cooled to room temperature.

The obtained product has an OH number of 327 mg KOH/g and an acid number of 0.0 mg KOH/g.

Preparation of the Alkoxylated Phosphoric Acid P-2:

346.6 g of monophosphoric acid (85% by weight) and 103.9 g of a propylene glycol ethoxylate (OH number 190 mg KOH/g) were initially charged in a 10 liter laboratory autoclave and heated to 100° C. with stirring (200 rpm) in a nitrogen atmosphere. After cooling of the autoclave contents to 80° C. and increasing of the stirrer speed to 450 rpm the pressure in the autoclave was adjusted to 2 bar (absolute) using nitrogen. 1321.6 g of ethylene oxide were then metered into the head space of the autoclave at 80° C. with stirring (450 rpm) over a period of 5.1 hours. After a postreaction time of 4 hours at 80° C., volatile constituents were removed at 80° C. and under vacuum (30 mbar) over a period of 60 minutes. After cooling to room temperature, 0.701 g of IRGANOX® 1076 (commercially available from BASF SE) was added.

The obtained product has an OH number of 332 mg KOH/g and an acid number of 72 mg KOH/g.

Preparation of Component K-1 with Maleic Anhydride and P-1 with Subsequent Alkoxylation:

252 g of P-1 and 51.1 g of maleic anhydride were placed in a 2 liter pressure reactor and heated to 100° C. After 4 hours of stirring (800 rpm) at 100° C. the mixture was cooled to 80° C. and the pressure in the reactor was adjusted to 2.1 bar (absolute) using nitrogen. 317 g of ethylene oxide were then metered into the reactor at 80° C. with stirring (800 rpm) at a metering rate of 150 g/h (step (1)). After a postreaction time of 3 hours at 80° C., volatile components were distilled off at 90° C. under reduced pressure (10 mbar (absolute)) for 30 minutes and the reaction mixture was then cooled to room temperature (step (2)).

The obtained product has an OH number of 258 mg KOH/g and an acid number of 28.5 mg KOH/g.

Preparation of Component K-2 with Phthalic Anhydride and P-1 with Subsequent Alkoxylation:

251 g of P-1 and 153.4 g of phthalic anhydride were placed in a 2 liter pressure reactor and heated to 120° C. After 3 hours of stirring (800 rpm) at 120° C. the mixture was cooled to 80° C. and the pressure in the reactor was adjusted to 2.1 bar (absolute) using nitrogen. 247 g of ethylene oxide were then metered into the reactor at 80° C. with stirring (800 rpm) at a metering rate of 150 g/h (step (1)). After a postreaction time of 3 hours at 80° C., volatile components were distilled off at 90° C. under reduced pressure (10 mbar (absolute)) for 30 minutes and the reaction mixture was then cooled to room temperature (step (2)).

The obtained product has an OH number of 164 mg KOH/g and an acid number of 49.0 mg KOH/g.

Preparation of Component K-3 with Phthalic Anhydride and P-1 with Subsequent Alkoxylation:

255 g of P-1 and 78.0 g of phthalic anhydride were placed in a 2 liter pressure reactor and heated to 120° C. After 3 hours of stirring (800 rpm) at 120° C. the mixture was cooled to 80° C. and the pressure in the reactor was adjusted to 2.1 bar (absolute) using nitrogen. 270 g of ethylene oxide were then metered into the reactor at 80° C. with stirring (800 rpm) at a metering rate of 150 g/h (step (1)). After a postreaction time of 3 hours at 80° C., volatile components were distilled off at 90° C. under reduced pressure (10 mbar (absolute)) for 30 minutes and the reaction mixture was then cooled to room temperature (step (2)).

The obtained product has an OH number of 239 mg KOH/g and an acid number of 25.6 mg KOH/g.

Preparation of Component K-4 with Methyl Acetoacetate and P-2:

300.35 g of P-2 were initially charged in a four-necked flask equipped with a stirrer, heating mantle, temperature sensor, distillation bridge, reflux condenser, nitrogen blanketing and a vacuum connection. 172.9 g of methyl acetoacetate were added. Over one hour the temperature was raised to 140° C. with stirring. Upon reaching this temperature a light vacuum (400 mbar) was applied and the reaction mixture was kept at 140° C. and 400 mbar for a period of 2 hours. The reaction mixture was then kept at 21 mbar and 140° C. for a further 90 min. After cooling to room temperature the product was decanted off.

The obtained product has an acid number of 34 mg KOH/g.

Preparation of Component K-5 with Dimethyl Malonate and P-2 with Subsequent Alkoxylation:

512.0 g of P-2 were initially charged in a four-necked flask equipped with a stirrer, heating mantle, temperature sensor, distillation bridge, reflux condenser, nitrogen blanketing and a vacuum connection. 146.49 g of dimethyl malonate were added. Over 53 minutes the temperature was raised to 140° C. with stirring. Upon reaching this temperature a light vacuum (600 mbar) was applied and the reaction mixture was kept at 140° C. and 600 mbar for a period of 4 hours. The reaction mixture was then kept at 21 mbar and 140° C. for a further 90 min. After cooling to room temperature the product was decanted off.

311.3 g of the intermediate were initially charged into a 2 liter laboratory autoclave and then heated to 60° C. in a nitrogen atmosphere. The pressure was then adjusted to 2.7 bar (absolute) using nitrogen. 141.1 g of ethylene oxide were then metered into the head space of the autoclave at 60° C. with stirring (800 rpm) over a period of 1.6 hours (step (1)). After a postreaction time of 5 hours at 60° C., volatile constituents were removed at 60° C. under vacuum (50 mbar) over a period of 30 minutes (step (2)). After cooling to room temperature, 0.288 g of IRGANOX® 1076 was added.

The obtained product has an OH number of 210 mg KOH/g and an acid number of 0.7 mg KOH/g.

Preparation of Component K-6 with Diethyl Malonate and P-2 with Subsequent Alkoxylation:

506.97 g of P-2 were initially charged in a four-necked flask equipped with a stirrer, heating mantle, temperature sensor, distillation bridge, reflux condenser, nitrogen blanketing and a vacuum connection. 173.33 g of diethyl malonate were added. Over 1.5 hours the temperature was raised to 140° C. with stirring. Upon reaching this temperature a light vacuum (600 mbar) was applied and the reaction mixture was kept at 140° C. and 600 mbar for a period of 4 hours. The reaction mixture was then kept at 21 mbar and 140° C. for a further 90 min. After cooling to room temperature the product was decanted off.

399.0 g of the intermediate were initially charged into a 2 liter laboratory autoclave and then heated to 60° C. in a nitrogen atmosphere. The pressure was then adjusted to 2.8 bar (absolute) using nitrogen. 171.0 g of ethylene oxide were then metered into the head space of the autoclave at 60° C. with stirring (800 rpm) over a period of 1.8 hours (step (1)). After a postreaction time of 5 hours at 60° C., volatile constituents were removed at 60° C. under vacuum (30 mbar) over a period of 30 minutes (step (2)). After cooling to room temperature, 0.298 g of IRGANOX® 1076 was added.

The obtained product has an OH number of 197 mg KOH/g and an acid number of 0.5 mg KOH/g.

Production of Laboratory Flexible Foams:

The flexible polyurethane foams described in Table 1 were produced in a batchwise process. The components were mixed by means of a Pendraulik LM 34 laboratory mixer.

Component A1-1 (125 g) was weighed out in a 500 mL paper cup together with components B1-1, B2-1 and C-1 and premixed with a high-speed stirrer for 10 seconds. This was followed by the addition of component B1-2 and mixing at the same stirrer speed for 10 seconds. Finally, component D-1 was added to this mixture, which was mixed for 7 seconds, and the mixture was transferred to a prepared paper box having dimensions of 20 cm×20 cm×15 cm.

The height of the flexible polyurethane foam blocks was about 14-15 cm. The finished flexible polyurethane foam was stored in the paper box for about 20-24 hours before being sawn into specimens for testing. The compressive strength and foam density of the flexible polyurethane foams were determined in accordance with DIN EN ISO 3386-1-98.

When using a component A5 this was initially pre-stirred into the component A1-1 before the remaining formulation components were added as described above.

Results

Without component K the resulting flexible polyurethane foam exhibited a high emission of cyclic propylene carbonate (comparative example 1); the use of an alkoxylated phosphoric acid makes it possible to reduce this emission (comparative examples 2 and 6). Surprisingly, the addition of a component K, i.e. a reaction product of alkoxylated phosphoric acid with a 1,3-dicarbonyl compound or a carboxylic anhydride, results in lower values for cyclic propylene carbonate in the emission determination (examples 3 to 5 and 7 to 9) compared to comparative examples 1, 2 and 6.

TABLE 1
Laboratory flexible foams

| | | Example | | | | | | | | |
|---|---|---|---|---|---|---|---|---|---|---|
| COMPONENT | | 1* | 2* | 3 | 4 | 5 | 6* | 7 | 8 | 9 |
| A1-1 | [pts. by wt.] | 100 | 100 | 100 | 100 | 100 | 100 | 100 | 100 | 100 |
| B1-1 | [pts. by wt.] | 0.12 | 0.12 | 0.12 | 0.12 | 0.12 | 0.12 | 0.12 | 0.12 | 0.12 |
| B1-2 | [pts. by wt.] | 0.18 | 0.18 | 0.18 | 0.18 | 0.18 | 0.18 | 0.18 | 0.18 | 0.18 |
| B2-1 | [pts. by wt.] | 1.20 | 1.20 | 1.20 | 1.20 | 1.20 | 1.20 | 1.20 | 1.20 | 1.20 |
| C-1 | [pts. by wt.] | 4.50 | 4.50 | 4.50 | 4.50 | 4.50 | 4.50 | 4.50 | 4.50 | 4.50 |
| P-1 | [pts. by wt.] | — | 1.0 | — | — | — | — | — | — | — |
| P-2 | [pts. by wt.] | — | — | — | — | — | 1.0 | — | — | — |
| K-1 | [pts. by wt.] | — | — | 1.0 | — | — | — | — | — | — |
| K-2 | [pts. by wt.] | — | — | — | 1.0 | — | — | — | — | — |
| K-3 | [pts. by wt.] | — | — | — | — | 1.0 | — | — | — | — |
| K-4 | [pts. by wt.] | — | — | — | — | — | — | 1.0 | — | — |
| K-5 | [pts. by wt.] | — | — | — | — | — | — | — | 1.0 | — |
| K-6 | [pts. by wt.] | — | — | — | — | — | — | — | — | 1.0 |
| D-1 | [pts. by wt.] | 56.01 | 56.01 | 56.01 | 56.01 | 56.01 | 56.01 | 56.01 | 56.01 | 56.01 |
| Index | | 108 | 108 | 108 | 108 | 108 | 108 | 108 | 108 | 108 |
| Apparent density | kg m⁻³ | 27.86 | 25.23 | 25.61 | 24.63 | 24.76 | 25.16 | 25.68 | 24.38 | 24.68 |
| Compressive strength at 40% | kPa | 5.02 | 5.69 | 6.78 | 5.46 | 6.52 | 6.72 | 5.46 | 5.42 | 5.48 |
| compression (4th cycle) | | | | | | | | | | |
| Cycl. propylene carbonate | [mg/kg] | 92 | 19 | 9 | 12 | 7 | 34 | 7 | 14 | 13 |

*comparative example

1. A process for producing polyurethane foams by reaction of the components:
A polyol component, comprising
A1 40 to 100 parts by weight of polyether carbonate polyol having a hydroxyl number according to DIN 53240-1 (June 2013) of 20 mg KOH/g to 120 mg KOH/g
A2 0 to 60 parts by weight of polyether polyol having a hydroxyl number according to DIN 53240-1 (June 2013) of 20 mg KOH/g to 250 mg KOH/g and a content of ethylene oxide of 0% to 60% by weight, wherein polyether polyol A2 is free from carbonate units,
B
B1 catalyst, and
B2 optionally auxiliary and additive substances,
C water and/or physical blowing agents,
with
D di- and/or polyisocyanates,
wherein production is carried out at an index of 90 to 120 and in the presence of a component K,
wherein the component K comprises a reaction product of alkoxylated phosphoric acid with 1,3-dicarbonyl compound or carboxylic anhydride and was optionally alkoxylated in at least one subsequent step, and
wherein the component K is employed in an amount of 0.05 to 10.00 parts by weight based on the sum of the parts by weight of components A1+A2=100 parts by weight.

2. The process as claimed in claim 1, wherein component A has the following composition:
A1 40 to 100 parts by weight of polyether carbonate polyol having a hydroxyl number according to DIN 53240-1 (June 2013) of 20 mg KOH/g to 120 mg KOH/g,
A2 0 to 60 parts by weight of polyether polyol having a hydroxyl number according to DIN 53240-1 (June 2013) of 20 mg KOH/g to 250 mg KOH/g and a content of ethylene oxide of 0% to 60% by weight, wherein polyether polyol A2 is free from carbonate units,
A3 0 to 20 parts by weight, based on the sum of the parts by weight of the components A1 and A2, of polyether polyol having a hydroxyl number according to DIN 53240-1 (June 2013) of 20 mg KOH/g to 250 mg KOH/g and a content of ethylene oxide of >60% by weight, wherein polyether polyol A3 is free from carbonate units,
A4 0 to 40 parts by weight, based on the sum of the parts by weight of the components A1 and A2, of polymer polyol, PUD polyol and/or PIPA polyol,
A5 40 to 0 parts by weight, based on the sum of the parts by weight of the components A1 and A2, of polyol which does not fall under the definition of the components A1 to A4,
wherein the reported parts by weight of the components A3, A4 and A5 are in each case based on the sum of the parts by weight of A1+A2=100 parts by weight.

3. The process as claimed in claim 1, wherein component A is free from components A3 and/or A4.

4. The process as claimed in claim 1, wherein component A comprises:
A1 65 to 75 parts by weight of polyether carbonate polyol having a hydroxyl number according to DIN 53240-1 (June 2013) of 20 mg KOH/g to 120 mg KOH/g, and
A2 25 to 35 parts by weight of polyether polyol having a hydroxyl number according to DIN 53240-1 (June 2013) of 20 mg KOH/g to 250 mg KOH/g and a content of ethylene oxide of 0% to 60% by weight, wherein polyether polyol A2 is free from carbonate units.

5. The process as claimed in claim 1, wherein component A1 comprises a polyether carbonate polyol obtainable by copolymerization of carbon dioxide and alkylene oxide in the presence of H-functional starter molecules.

6. The process as claimed in claim 1, wherein, as component B,
B1 catalyst selected from one or more of the following compounds
a) aliphatic tertiary amines, cycloaliphatic tertiary amines, aliphatic amino ethers, cycloaliphatic amino ethers, aliphatic amidines, cycloaliphatic amidines, urea and derivatives of urea, and/or
b) tin(II) salts of carboxylic acids, and
B2 optionally auxiliary and additive substances
are employed.

7. The process as claimed in claim 1, wherein, as component B,
B1 catalyst and
B2 optionally auxiliary and additive substances
are employed,
wherein, as component B1:
B1.1 0.05 to 1.50 parts by weight, based on the sum of the parts by weight of the components A1 and A2, of urea and/or derivatives of urea and
B1.2 0.03 to 1.50 parts by weight, based on the sum of the parts by weight of the components A1 and A2, of catalyst other than those of the component B1.2, wherein the content of amine catalyst in the component B1.2 is not more than 50% by weight based on component B1,
is employed.

8. The process as claimed in claim 1, wherein component D contains 2,4- and/or 2,6-TDI.

9. The process as claimed in claim 1, wherein the component K contains a reaction product of alkoxylated phosphoric acid with a compound selected from the group consisting of acetoacetate ester, malonate ester, phthalic anhydride, and maleic anhydride.

10. The process as claimed in claim 1, wherein the alkoxylated phosphoric acid is an ethoxylated phosphoric acid.

11. The process as claimed in claim 1, wherein component K is employed in an amount of 0.5 to 6.0 parts by weight based on the sum of the parts by weight of components A1+A2=100 parts by weight.

12. The process as claimed in claim 1, wherein the component K was subsequently alkoxylated by being
(1) initially charged into a reactor and reacted with alkylene oxide at 60° C. to 100° C. in an inert gas atmosphere,
and optionally
(2) volatile components are removed under vacuum at a temperature of 80° C. to 100° C.

13. A polyurethane foam obtainable by a process as claimed in claim 1.

14. The polyurethane foam as claimed in claim 13, wherein the polyurethane foam is a flexible polyurethane foam.

15. A method for producing furniture cushioning, textile inserts, mattresses, automotive seats, headrests, armrests, sponges, and/or foam sheetings for use in automotive components, comprising utilizing the polyurethane foam as claimed in claim 13.

16. The process as claimed in claim 5, wherein the polyether carbonate polyol has a CO2 content of 15% to 25% by weight.

17. The method as claimed in claim 15, wherein the automotive components are selected from the group consisting of roof headlinings, door trim, seat covers, and constructional elements.
